(19) United States
(12) Patent Application Publication
(10) Pub. No.: US 2026/0111559 A1
(43) Pub. Date: Apr. 23, 2026

(54) APPLICATION ASSOCIATION RISK DETECTION USING ASSOCIATION RULE LEARNING

(71) Applicant: OKTA, INC., SAN FRANCISCO, CA (US)

(72) Inventor: Tanvir ISLAM, Lake Stevens, WA (US)

(21) Appl. No.: 18/920,563

(22) Filed: Oct. 18, 2024

(51) Int. Cl. G06F 21/57

(52) U.S. Cl. CPC G06F 21/577; G06F 2221/033

(57) ABSTRACT

An authentication and authorization system associated with an identity management system may receive a set of access patterns from two or more applications that are associated with a set of users and may indicate which of the two or more applications a respective user has access to. The system may generate association rules that are based on the set of access patterns to indicate associations between the two or more applications and the set of users. Moreover, for each respective user, the system may generate an indication of a likelihood that the respective user is associated with a security risk by accessing the two or more applications that is based on the association rules and one or more parameters associated with the respective user. The system may then generate an indication of actions for the system to execute in response to a respective user being associated with the security risk.

### FIELD OF TECHNOLOGY

The present disclosure relates generally to identity management, and more specifically to application association risk detection using association rule learning.

### BACKGROUND

An identity management system may be employed to manage and store various forms of user data, including usernames, passwords, email addresses, permissions, roles, group memberships, etc. The identity management system may provide authentication services for applications, devices, users, and the like. The identity management system may enable organizations to manage and control access to resources, for example, by serving as a central repository that integrates with various identity sources. The identity management system may provide an interface that enables users to access a multitude of applications with a single set of credentials.

In some examples, an identity management system may store access patterns associated indicating applications that a respective user has access to. In some cases, as the quantity of users, the quantity of applications, or both, may be relatively large, administrative users may be unable to accurately and effectively manage access patterns. For example, various access patterns may indicate potential security risks to the identity management system that an administrative user may be unable to detect due to the relatively large quantity of applications, users, or both.

### SUMMARY

A method for application-based risk detection by an authentication and authorization system is described. The method may include receiving, from two or more applications, a first set of access patterns associated with a set of multiple users, the first set of access patterns indicating which of the two or more applications that a respective user has access to, generating, based on receiving the first set of access patterns, a first set of association rules that are based on the first set of access patterns, the first set of association rules indicating associations between the two or more applications and the set of multiple users, generating, for each respective user, an indication of a likelihood that the respective user is associated with a security risk by accessing the two or more applications based on the first set of association rules and one or more parameters associated with the respective user, and generating an indication of one or more actions for execution by the authentication and authorization system based on the likelihood that the respective user is associated with the security risk.

An authentication and authorization system for application-based risk detection is described. The authentication and authorization system may include one or more memories storing processor executable code, and one or more processors coupled with the one or more memories. The one or more processors may individually or collectively be operable to execute the code to cause the authentication and authorization system to receive, from two or more applications, a first set of access patterns associated with a set of multiple users, the first set of access patterns indicating which of the two or more applications that a respective user has access to, generate, based on receiving the first set of access patterns, a first set of association rules that are based on the first set of access patterns, the first set of association rules indicating associations between the two or more applications and the set of multiple users, generate, for each respective user, an indication of a likelihood that the respective user is associated with a security risk by accessing the two or more applications based on the first set of association rules and one or more parameters associated with the respective user, and generate an indication of one or more actions for execution by the authentication and authorization system based on the likelihood that the respective user is associated with the security risk.

Another authentication and authorization system for application-based risk detection is described. The authentication and authorization system may include means for receiving, from two or more applications, a first set of access patterns associated with a set of multiple users, the first set of access patterns indicating which of the two or more applications that a respective user has access to, means for generating, based on receiving the first set of access patterns, a first set of association rules that are based on the first set of access patterns, the first set of association rules indicating associations between the two or more applications and the set of multiple users, means for generating, for each respective user, an indication of a likelihood that the respective user is associated with a security risk by accessing the two or more applications based on the first set of association rules and one or more parameters associated with the respective user, and means for generating an indication of one or more actions for execution by the authentication and authorization system based on the likelihood that the respective user is associated with the security risk.

A non-transitory computer-readable medium storing code for application-based risk detection is described. The code may include instructions executable by one or more processors to receive, from two or more applications, a first set of access patterns associated with a set of multiple users, the first set of access patterns indicating which of the two or more applications that a respective user has access to, generate, based on receiving the first set of access patterns, a first set of association rules that are based on the first set of access patterns, the first set of association rules indicating associations between the two or more applications and the set of multiple users, generate, for each respective user, an indication of a likelihood that the respective user is associated with a security risk by accessing the two or more applications based on the first set of association rules and one or more parameters associated with the respective user, and generate an indication of one or more actions for execution by the authentication and authorization system based on the likelihood that the respective user is associated with the security risk.

Some examples of the method, authentication and authorization systems, and non-transitory computer-readable medium described herein may further include operations, features, means, or instructions for receiving, from the two or more applications, one or more access request messages from the set of multiple users and aggregating the one or more access request messages into the first set of access patterns, where receiving the first set of access patterns may be based on aggregating the one or more access request messages.

Some examples of the method, authentication and authorization systems, and non-transitory computer-readable medium described herein may further include operations, features, means, or instructions for displaying, via a user interface, one or more users of the set of multiple users that may be associated with the security risk based on the likelihood that the one or more users may be associated with the security risk satisfying a threshold and displaying, via the user interface and based on the one or more users satisfying the threshold, the indication of the one or more actions for the one or more users, where the indication of the one or more actions may be generated based on the one or more users satisfying the threshold.

Some examples of the method, authentication and authorization systems, and non-transitory computer-readable medium described herein may further include operations, features, means, or instructions for identifying that the likelihood that the respective user may be associated with the security risk satisfies a threshold and executing, automatically and in response to generating the indication of the one or more actions, the one or more actions based on identifying satisfaction of the threshold.

Some examples of the method, authentication and authorization systems, and non-transitory computer-readable medium described herein may further include operations, features, means, or instructions for transmitting, to a first user, the indication of the one or more actions for execution by the authentication and authorization system, receiving, from the first user and based on transmitting the indication, a selection of at least one action of the one or more actions, and executing the at least one action based on receiving the selection from the first user.

Some examples of the method, authentication and authorization systems, and non-transitory computer-readable medium described herein may further include operations, features, means, or instructions for receiving, from a first user, a request to generate the indication of the likelihood that the respective user may be associated with the security risk for the set of multiple users, where generation of the indication of the likelihood that the respective user may be associated with the security risk may be based on receiving the request from the first user.

In some examples of the method, authentication and authorization systems, and non-transitory computer-readable medium described herein, generating the first set of association rules may include operations, features, means, or instructions for generating an itemset including the first set of access patterns, calculating, utilizing the itemset, a support parameter that indicates a frequency of a first application and a second application within the itemset, calculating, utilizing the itemset and based on the support parameter, a confidence parameter that indicates a quantity of access patterns of the first set of access patterns that include both the first application and the second application, and calculating, utilizing the itemset and based on both the support parameter and the confidence parameter, a lift parameter that indicates an association between the first application and the second application, where the first set of association rules may be based on the lift parameter for each pair of applications of the two or more applications.

In some examples of the method, authentication and authorization systems, and non-transitory computer-readable medium described herein, the association indicated by the lift parameter may be a positive association, a negative association, or a neutral association, based on a value of the lift parameter.

Some examples of the method, authentication and authorization systems, and non-transitory computer-readable medium described herein may further include operations, features, means, or instructions for identifying, from the applications that the respective user may have access to, at least one application pair of a set of application pairs with a lift parameter value indicating a negative association, the likelihood that the respective user may be associated with the security risk being based on the at least one application pair being associated with a negative association, where generating the indication of the likelihood that the respective user may be associated with the security risk may be based on identifying the at least one application pair.

In some examples of the method, authentication and authorization systems, and non-transitory computer-readable medium described herein, the first set of access patterns may be stored at a database, a data store, a cloud-based platform, or any combination thereof.

In some examples of the method, authentication and authorization systems, and non-transitory computer-readable medium described herein, the one or more actions include an adjustment to an access parameter of a respective application for the respective user, an adjustment of the one or more parameters associated with the respective user, an adjustment of the two or more applications that the respective user may have access to, or any combination thereof.

### BRIEF DESCRIPTION OF THE DRAWINGS

FIG. 1 illustrates an example of a computing system that supports application association risk detection using association rule learning in accordance with aspects of the present disclosure.

FIG. 2 shows an example of a computing system that supports application association risk detection using association rule learning in accordance with aspects of the present disclosure.

FIG. 3 shows an example of a block diagram of an authentication and authorization system that supports application association risk detection using association rule learning in accordance with aspects of the present disclosure.

FIG. 4 shows an example of a process flow that supports application association risk detection using association rule learning in accordance with aspects of the present disclosure.

FIG. 5 shows a block diagram of an apparatus that supports application association risk detection using association rule learning in accordance with aspects of the present disclosure.

FIG. 6 shows a block diagram of an authentication service that supports application association risk detection using association rule learning in accordance with aspects of the present disclosure.

FIG. 7 shows a diagram of a system including a device that supports application association risk detection using association rule learning in accordance with aspects of the present disclosure.

FIG. 8 shows a flowchart illustrating methods that support application association risk detection using association rule learning in accordance with aspects of the present disclosure.

### DETAILED DESCRIPTION

In some examples, users of an organization may have access to various applications. Further, organizations may have a relatively large quantity of applications that users may be capable of accessing, a relatively large quantity of users within the organization, or both. In some cases, when accessing an application, an indication (e.g., an access indication) may be stored for an administrative user of the organization to view. Such access indications may also be referred to as access events or syslog events, and may be included within access patterns. For example, based on the stored access indications or events, access patterns may be identified for users, and may indicate which applications a respective user has access to and a quantity of access attempts that are successful, unsuccessful, both. However, due to the relatively large quantity of applications, the relatively large quantity of users within an organization, or both, administrative users may be unable to view, determine, or identify all the access patterns. Thus, the administrative users may be unable to detect any errors in the access patterns or security risks the access patterns present. For example, one or more users may have access to applications that they should not have access to, and such access capability may go undetected, which can present a security risk for the organization.

To ensure that an organization is able to efficiently and reliably detect risks associated with access patterns, the techniques of the present disclosure may describe techniques for an authentication and authorization system to identify such security risks and recommend actions to mitigate any identified security risk. For example, an authentication and authorization system may receive a first set of access patterns associated with a set of users from two or more applications, and the first set of access patterns may indicate which of the two or more applications that a respective user has access to and the two or more applications that the respective user has accessed. Thus, the first set of access patterns may indicate that a respective user has access to an application, has accessed an application, the time of the access, or any combination thereof. Based on receiving the first set of access patterns, the authentication and authorization system may then generate a first set of association rules that are based on the first set of access patterns. Moreover, the first set of association rules may indicate associations between the two or more applications and the set of users. Further, the authentication and authorization system may generate, for each respective user, an indication of a likelihood that the respective user is associated with a security risk based on having access to certain applications. As described herein, the security risk of a respective user may be a security risk associated with a user having access to a first application and a second application where a user having access to both applications together may result in an unsecure computing system. In response, the authentication and authorization system may generate an indication of one or more actions for execution by the authentication and authorization system based on the likelihood that the respective user is associated with the security risk by accessing the two or more applications.

In some cases, the authentication and authorization system may display the indication of the likelihood that a respective user is associated with a security risk via a user interface. Moreover, the display may indicate the two or more applications that the respective user have access to that is resulting in a security risk for a computing system. Further, the user interface may also display the one or more actions for a subset of the users based on a threshold being satisfied indicating that the subset of the users are associated with the security risk. Additionally, or alternatively, in response to identifying that the likelihood that a respective user is associated with the security risk satisfies a threshold, the authentication and authorization system may automatically execute the one or more actions. In some cases, the one or more actions may include adjusting an access parameter for a respective application for the respective user, an adjustment of the one or more parameters associated with the respective user, an adjustment of the two or more applications that the respective user has access to, or any combination thereof.

Thus, the techniques of the present disclosure may ensure that an authentication and authorization system is capable of detecting security risks for an organization or tenant in an efficient manner. For example, a user having access to a respective combination of applications may provide an organization with a security risk and the authentication and authorization system may be capable of detecting such combination and associated security risk in accordance with the techniques of the present disclosure. Moreover, the techniques of the present disclosure may enable the authentication and authorization system to generate and execute one or more actions based on respective users being indicated as being associated with a security risk. Thus, the techniques of the present disclosure may enable the authentication and authorization system to detect respective users associated with security risks and perform actions in response to the detection to assist administrative users in providing a robust and secure system for an organization or tenant.

Aspects of the disclosure are initially described in the context of a computing system. Additional aspects of the disclosure are described with reference to a computing system, a block diagram, and a process flow. Aspects of the disclosure are further illustrated by and described with reference to apparatus diagrams, system diagrams, and flowcharts that relate to application association risk detection using association rule learning.

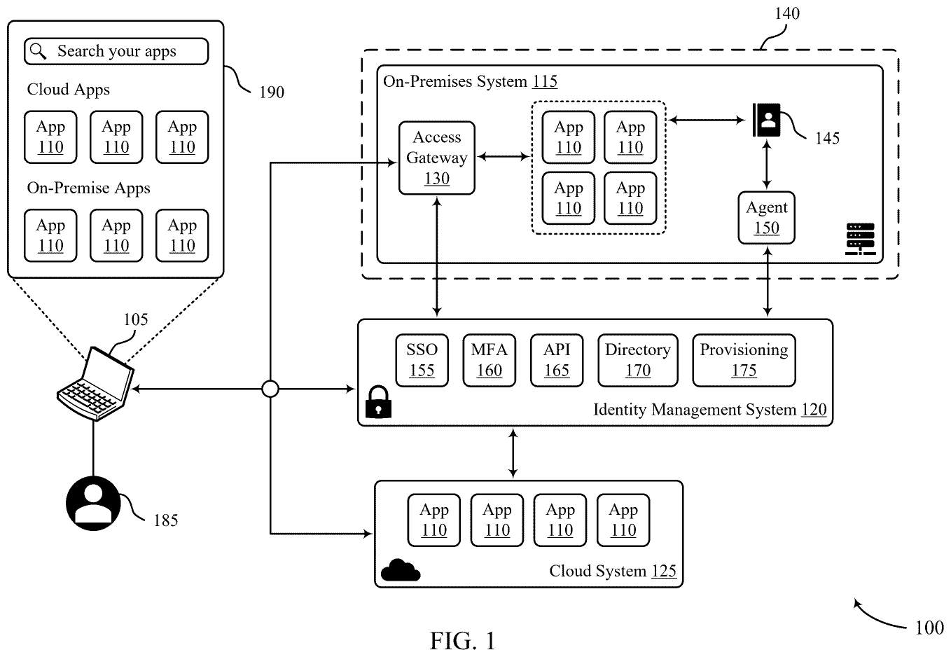

FIG. 1 illustrates an example of a computing system 100 that supports application association risk detection using association rule learning in accordance with various aspects of the present disclosure. The computing system 100 includes a computing device 105 (such as a desktop, laptop, smartphone, tablet, or the like), an on-premises system 115, an identity management system 120, and a cloud system 125, which may communicate with each other via a network, such as a wired network (e.g., the Internet), a wireless network (e.g., a cellular network, a wireless local area network (WLAN)), or both. In some cases, the network may be implemented as a public network, a private network, a secured network, an unsecured network, or any combination thereof. The network may include various communication links, hubs, bridges, routers, switches, ports, or other physical and/or logical network components, which may be distributed across the computing system 100.

The on-premises system 115 (also referred to as an on-premises infrastructure or environment) may be an example of a computing system in which a client organization owns, operates, and maintains its own physical hardware and/or software resources within its own data center(s) and facilities, instead of using cloud-based (e.g., off-site) resources. Thus, in the on-premises system 115, hardware, servers, networking equipment, and other infrastructure components may be physically located within the “premises” of the client organization, which may be protected by a firewall 140 (e.g., a network security device or software application that is configured to monitor, filter, and control incoming/outgoing network traffic). In some examples, users may remotely access or otherwise utilize compute resources of the on-premises system 115, for example, via a virtual private network (VPN).

In contrast, the cloud system 125 (also referred to as a cloud-based infrastructure or environment) may be an example of a system of compute resources (such as servers, databases, virtual machines, containers, and the like) that are hosted and managed by a third-party cloud service provider using third-party data center(s), which can be physically co-located or distributed across multiple geographic regions. The cloud system 125 may offer high scalability and a wide range of managed services, including (but not limited to) database management, analytics, machine learning (ML), artificial intelligence (AI), etc. Examples of cloud systems 125 include (AMAZON WEB SERVICES) AWS®, MICROSOFT AZURE®, GOOGLE CLOUD PLATFORM®, ALIBABA CLOUD®, ORACLE® CLOUD INFRASTRUCTURE (OCI), and the like.

The identity management system 120 may support one or more services, such as a single sign-on (SSO) service 155, a multi-factor authentication (MFA) service 160, an application programming interface (API) service 165, a directory management service 170, or a provisioning service 175 for various on-premises applications 110 (e.g., applications 110 running on compute resources of the on-premises system 115) and/or cloud applications 110 (e.g., applications 110 running on compute resources of the cloud system 125), among other examples of services. The SSO service 155, the MFA service 160, the API service 165, the directory management service 170, and/or the provisioning service 175 may be individually or collectively provided (e.g., hosted) by one or more physical machines, virtual machines, physical servers, virtual (e.g., cloud) servers, data centers, or other compute resources managed by or otherwise accessible to the identity management system 120.

A user 185 may interact with the computing device 105 to communicate with one or more of the on-premises system 115, the identity management system 120, or the cloud system 125. For example, the user 185 may access one or more applications 110 by interacting with an interface 190 of the computing device 105. In some implementations, the user 185 may be prompted to provide some form of identification (such as a password, personal identification number (PIN), biometric information, or the like) before the interface 190 is presented to the user 185. In some implementations, the user 185 may be a developer, customer, employee, vendor, partner, or contractor of a client organization (such as a group, business, enterprise, non-profit, or startup that uses one or more services of the identity management system 120). The applications 110 may include one or more on-premises applications 110 (hosted by the on-premises system 115), mobile applications 110 (configured for mobile devices), and/or one or more cloud applications 110 (hosted by the cloud system 125).

The SSO service 155 of the identity management system 120 may allow the user 185 to access multiple applications 110 with one or more credentials. Once authenticated, the user 185 may access one or more of the applications 110 (for example, via the interface 190 of the computing device 105). That is, based on the identity management system 120 authenticating the identity of the user 185, the user 185 may obtain access to multiple applications 110, for example, without having to re-enter the credentials (or enter other credentials). The SSO service 155 may leverage one or more authentication protocols, such as Security Assertion Markup Language (SAML) or OpenID Connect (OIDC), among other examples of authentication protocols. In some examples, the user 185 may attempt to access an application 110 via a browser. In such examples, the browser may be redirected to the SSO service 155 of the identity management system 120, which may serve as the identity provider (IdP). For example, in some implementations, the browser (e.g., the user's request communicated via the browser) may be redirected by an access gateway 130 (e.g., a reverse proxy-based virtual application configured to secure web applications 110 that may not natively support SAML or OIDC).

In some examples, the access gateway 130 may support integrations with legacy applications 110 using hypertext transfer protocol (HTTP) headers and Kerberos tokens, which may offer universal resource locator (URL)-based authorization, among other functionalities. In some examples, such as in response to the user's request, the IdP may prompt the user 185 for one or more credentials (such as a password, PIN, biometric information, or the like) and the user 185 may provide the requested authentication credentials to the IdP. In some implementations, the IdP may leverage the MFA service 160 for added security. The IdP may verify the user's identity by comparing the credentials provided by the user 185 to credentials associated with the user's account. For example, one or more credentials associated with the user's account may be registered with the IdP (e.g., previously registered, or otherwise authorized for authentication of the user's identity via the IdP). The IdP may generate a security token (such as a SAML token or Oath 2.0 token) containing information associated with the identity and/or authentication status of the user 185 based on successful authentication of the user's identity.

The IdP may send the security token to the computing device 105 (e.g., the browser or application 110 running on the computing device 105). In some examples, the application 110 may be associated with a service provider (SP), which may host or manage the application 110. In such examples, the computing device 105 may forward the token to the SP. Accordingly, the SP may verify the authenticity of the token and determine whether the user 185 is authorized to access the requested applications 110. In some examples, such as examples in which the SP determines that the user 185 is authorized to access the requested application, the SP may grant the user 185 access to the requested applications 110, for example, without prompting the user 185 to enter credentials (e.g., without prompting the user to log-in). The SSO service 155 may promote improved user experience (e.g., by limiting the number of credentials the user 185 has to remember/enter), enhanced security (e.g., by leveraging secure authentication protocols and centralized security policies), and reduced credential fatigue, among other benefits.

The MFA service 160 of the identity management system 120 may enhance the security of the computing system 100 by prompting the user 185 to provide multiple authentication factors before granting the user 185 access to applications 110. These authentication factors may include one or more knowledge factors (e.g., something the user 185 knows, such as a password), one or more possession factors (e.g., something the user 185 is in possession of, such as a mobile app-generated code or a hardware token), or one or more inherence factors (e.g., something inherent to the user 185, such as a fingerprint or other biometric information). In some implementations, the MFA service 160 may be used in conjunction with the SSO service 155. For example, the user 185 may provide the requested login credentials to the identity management system 120 in accordance with an SSO flow and, in response, the identity management system 120 may prompt the user 185 to provide a second factor, such as a possession factor (e.g., a one-time passcode (OTP), a hardware token, a text message code, an email link/code). The user 185 may obtain access (e.g., be granted access by the identity management system 120) to the requested applications 110 based on successful verification of both the first authentication factor and the second authentication factor.

The API service 165 of the identity management system 120 can secure APIs by managing access tokens and API keys for various client organizations, which may enable (e.g., only enable) authorized applications (e.g., one or more of the applications 110) and authorized users (e.g., the user 185) to interact with a client organization's APIs. The API service 165 may enable client organizations to implement customizable login experiences that are consistent with their architecture, brand, and security configuration. The API service 165 may enable administrators to control user API access (e.g., whether the user 185 and/or one or more other users have access to one or more particular APIs). In some examples, the API service 165 may enable administrators to control API access for users via authorization policies, such as standards-based authorization policies that leverage OAuth 2.0. The API service 165 may additionally, or alternatively, implement role-based access control (RBAC) for applications 110. In some implementations, the API service 165 can be used to configure user lifecycle policies that automate API onboarding and off-boarding processes.

The directory management service 170 may enable the identity management system 120 to integrate with various identity sources of client organizations. In some implementations, the directory management service 170 may communicate with a directory service 145 of the on-premises system 115 via a software agent 150 installed on one or more computers, servers, and/or devices of the on-premises system 115. Additionally, or alternatively, the directory management service 170 may communicate with one or more other directory services, such as one or more cloud-based directory services. As described herein, a software agent 150 generally refers to a software program or component that operates on a system or device (such as a device of the on-premises system 115) to perform operations or collect data on behalf of another software application or system (such as the identity management system 120).

The provisioning service 175 of the identity management system 120 may support user provisioning and deprovisioning. For example, in response to an employee joining a client organization, the identity management system 120 may automatically create accounts for the employee and provide the employee with access to one or more resources via the accounts. Similarly, in response to the employee (or some other employee) leaving the client organization, the identity management system 120 may autonomously deprovision the employee's accounts and revoke the employee's access to the one or more resources (e.g., with little to no intervention from the client organization). The provisioning service 175 may maintain audit logs and records of user deprovisioning events, which may help the client organization demonstrate compliance and track user lifecycle changes. In some implementations, the provisioning service 175 may enable administrators to map user attributes and roles (e.g., permissions, privileges) between the identity management system 120 and connected applications 110, ensuring that user profiles are consistent across the identity management system 120, the on-premises system 115, and the cloud system 125.

In some examples, users 185 of an organization or tenant may have access to various applications 110. Further, the quantity of users 185 accessing the applications 110, the quantity of applications 110, or both, may be relatively large. Therefore, it may be relatively difficult for administrative users to manage the access of applications 110 and users 185 manually. For example, the identity management system 120 may store a list of access events when users 185 attempt to access various applications 110. In some cases, due to the relatively large quantity of applications 110, users 185, or both, the list of access events may be relatively large and an administrative user 185 may be unable to make any determinations, insights, or identifications of anything. However, administrative users 185 may be expected to understand the usage of the applications 110 by users 185 of an organization or tenant. For example, the administrative users 185 may be expected to be capable of detecting security risks but due to the relatively large list of access events, the administrative users 185 may be unable to do so thus resulting in a potentially insecure system (e.g., an on-premises system 115, an identity management system 120, a cloud system 125, or any combination thereof).

To ensure that an organization or tenant may be capable of efficiently and reliably detecting security risks, the techniques of the present disclosure may describe techniques for an authentication and authorization system to identify users 185 associated with security risks and recommend actions to mitigate any identified security risks. For example, an authentication and authorization system may receive a first set of access patterns associated with a set of users 185 from two or more applications 110 and the first set of access patterns may indicate which of the two or more applications 110 that a respective user 185 has access to. Based on receiving the first set of access patterns, the authentication and authorization system may then generate a first set of association rules that are based on the first set of access patterns and indicate association between the two or more applications 110 and the set of users 185. Further, the authentication and authorization system may generate, for each respective user 185, an indication of a likelihood that the respective user 185 is associated with a security risk by accessing the two or more applications 110 based on the first set of association rules and one or more parameters associated with the respective user 185. In response, the authentication and authorization system may generate an indication of one or more actions for execution by the authentication and authorization system based on the likelihood that the respective user 185 is associated with the security risk by accessing the two or more applications 110.

For example, a user 185 that is assigned a sales specialist role may have access to various communication applications 110 and sales-based applications 110 which may not pose any security risk. However, if the user 185 that is a sales specialist has access to developer applications 110, there may be a security risk. For example, having access to the developer application 110 may enable the sales specialist user 185 the ability of manipulating an application 110 such that the application 110 is at risk to be attacked by malicious actors. Further, in some cases, having access to a respective application 110 may give the user 185 access to privileged or confidential information that the user 185 should not have access to thus providing a security risk as it may be easier for a malicious actor to obtain the privileged or confidential information via the respective user 185 than traditional techniques. Thus, the techniques of the present disclosure may ensure that an authentication and authorization system is capable of detecting security risks for an organization or tenant, thus providing a secure system to the organization or tenant. Moreover, the techniques of the present disclosure may enable the authentication and authorization system to detect respective users 185 associated with security risks and perform actions in response to the detection to assist administrative users 185 in providing a robust and secure system for an organization or tenant.

Although not depicted in the example of FIG. 1, a person skilled in the art would appreciate that the identity management system 120 may support or otherwise provide access to any number of additional or alternative services, applications 110, platforms, providers, or the like. In other words, the functionality of the identity management system 120 is not limited to the exemplary components and services mentioned in the preceding description of the computing system 100. The description herein is provided to enable a person skilled in the art to make or use the present disclosure. Various modifications to the present disclosure will be readily apparent to those skilled in the art, and the generic principles defined herein may be applied to other variations without departing from the scope of the present disclosure. Accordingly, the present disclosure is not limited to the examples and designs described herein, but is to be accorded the broadest scope consistent with the principles and novel features disclosed herein.

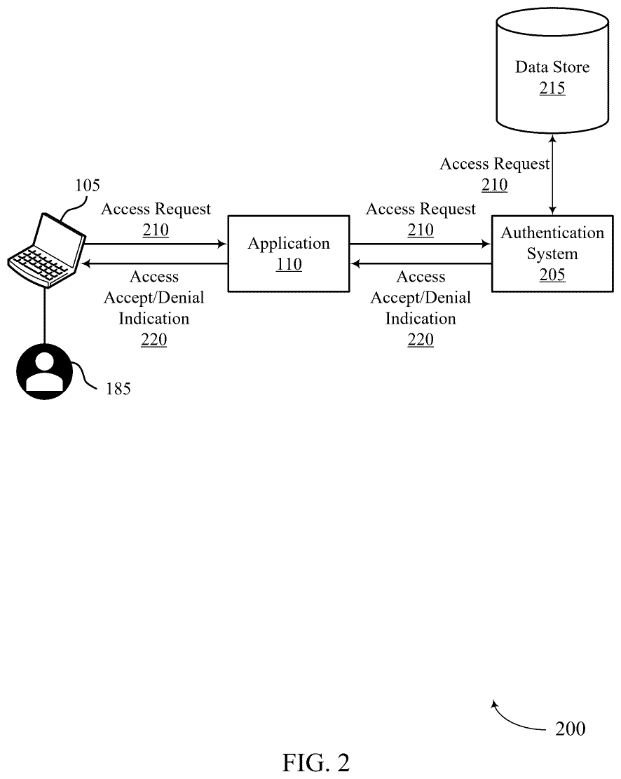

FIG. 2 shows an example of a computing system 200 that supports application association risk detection using association rule learning in accordance with aspects of the present disclosure. In some examples, the computing system 200 may implement or be implemented by the computing system 100. For example, the computing system 200 may include a computing device 105 that a user 185 can use to access an application 110, which may be examples of devices or services described with reference to FIG. 1. Further, when a user 185 attempts to access the application 110, the application 110 may communicate with an authentication and authorization system 205 to authenticate the user 185 and ensure that the user 185 has access to the application 110.

In some examples, an organization or tenant of a multi-tenant system may be associated with a set of users 185. Further, the organization or tenant may be associated with a set of applications 110 that various users 185 of the organization or tenant can access. Moreover, users 185 of an organization or tenant may be associated with various parameters. For example, a user 185 may be associated with an organization parameter to indicate the organization that the user 185 is associated with, a team or group parameter to indicate a team within the organization that the user 185 is within, a role parameter to indicate a role within a team or within the organization, or any combination thereof. Thus, when attempting to access an application 110, the user may transmit an access request 210 to the application 110 that includes the one or more parameters associated with the user 185.

Based on receiving the access request 210 from a user 185, the application 110 may forward or transmit the access request 210 to the authentication and authorization system 205 to determine whether the user 185 is capable of accessing the application 110. In some examples, when receiving the access request 210 from an application 110, the authentication and authorization system 205 may use the parameters associated with the user 185 to determine whether the user 185 has access to the application 110. Further, the authentication and authorization system 205 may store the access request 210 within a data store 215. In some examples, the data store 215 may be an example of a database, a cloud based platform, a syslog event storage, or any combination thereof. For example, when receiving the access request 210, the authentication and authorization system 205 may store the data store 215 within the data store 215 via an access event or syslog event. An access or syslog event may be generated by the application 110 to indicate an event that occurred at the application 110 such as an access attempt. As such, the data store 215 may store the access events from the application 110 and various other applications 110. In some cases, an organization may use a single data store 215 to store all access events from applications 110 associated with an organization, or the organization may utilize various data stores 215 for the various applications 110.

Further, to authenticate an access request 210, in some cases, the authentication and authorization system 205 may utilize a role-based access control mechanism to enforce authorization in applications 110 for a respective organization or tenant. Additionally, or alternatively, the authentication and authorization system 205 may utilize various application 110 access policies implemented by the respective organization or tenant. In response to the authentication and authorization system 205 receiving the access request 210, the authentication and authorization system 205 may transmit an access acceptance or denial indication 220 back to the application 110 indicating whether the user 185 is authorized to access the application 110. Further, the application 110 may then forward or transmit the access acceptance or denial indication 220 to the user 185 by either granting the user 185 access to the application 110 or denying the user 185 access to the application based on if the access acceptance or denial indication 220 indicates that the user is authorized to access the application 110.

However, in some cases, the application 110 access policies may be out-of-date or at least partially incorrect, a user 185 may have been assigned an incorrect role, or a combination thereof, thus resulting in a potential security risk for the organization or tenant. For example, roles may be assigned to users 185 manually which may result in a user 185 being assigned the wrong role during onboarding when the user 185 joined the organization, thus potentially giving the user 185 access to one or more applications 110 that the user 185 should not have access to. In another example, based on an incorrect application 110 access policy or a user 185 being assigned an incorrect role, a user 185 may be given privileged access to applications 110 which can pose a security risk to an organization. Additionally, or alternatively, incorrect access to applications 110 can result in user 185 accounts being compromised thus resulting in malicious actors being capable of accessing personal information of users 185.

For example, an organization may have three users split between two teams. The first team may be an engineering team that includes a first user 185 that has access to typical engineering-related applications 110 and various productivity applications 110 such as an email application 110 and a group-based communication platform application 110. The second team may be a sales team that includes a second user 185 and a third user 185. In some cases, the second user 185 and the third user 185 may have access to sales-related applications 110 and the various productivity applications 110. However, the third user 185 may also have access to one or more engineering-related applications 110. As such, having the third user 185 have access to both sales-related applications 110 and engineering-related applications 110 may be an association that can pose a security risk to the organization. For example, the third user 185 may have access to data within the engineering-related applications 110 that is private and confidential. Further, since the third user 185 is not typically granted access to confidential data, accounts associated with the third user 185 may be less secure than accounts associated with users 185 that regularly work with confidential data. Thus, malicious actors may target the accounts of the third user 185 to gain access to the private and confidential data and may be capable of obtaining access to the accounts relatively easier due to the lack of security typically implemented when a user 185 has access to private and confidential data.

To prevent an organization or tenant from having security risks, the techniques of the present disclosure may enable the authentication and authorization system 205 to determine application 110 association risks via association rule learning. For example, due the relatively large quantity of applications 110 and users 185 of an organization, it may be inefficient and unreliable to have an administrative user 185 manually determine security risks based on access patterns indicated via the access events stored in the data store 215. Thus, the techniques of the present disclosure may describe the authentication and authorization system 205 identifying access patterns for the users 185 of an organization to determine which applications 110 each user 185 has access to and determining a likelihood that a user 185 is associated with a security risk (e.g., a risk score) based on association rules generated by the authentication and authorization system 205. Moreover, the security risk may be based on an association between two or more applications 110 providing a security risk to the computing system 200.

Therefore, in accordance with the techniques of the present disclosure, the authentication and authorization system 205 may determine or identify that a user 185 is associated with a security risk by accessing two or more applications 110 based on an association of applications 110 that the user 185 has access to. For example, a sales user 185 may be unlikely to have access to an engineering-related application 110 and a sales-related application 110. Thus, the authentication and authorization system 205 may determine that association of the applications and thus the user 185 may have a relatively high likelihood of being associated with a security risk (e.g., the user 185 is associated with a relatively high risk score based on having access to the engineering-related application 110 and the sales-based application 110). For example, the association may be a negative association indicating that the engineering-related application 110 and the sales-related application 110 are unrelated and there is no reason for a user 185 to have access to both applications 110. Further, the techniques of the present disclosure may describe the authentication and authorization system 205 generating a recommendation of one or more actions for the authentication and authorization system 205 to perform in response to a user 185 being associated with a security risk by having access to the two or more applications 110. For example, the authentication and authorization system 205 may generate a user interface displaying the likelihood that each user 185 is associated with a security risk, the applications 110 causing the security risk due to their associations, and the one or more actions an administrative user 185 can have the authentication and authorization system 205 execute to mitigate the security risk of having access to the two or more applications 110. Additionally, or alternatively, the authentication and authorization system 205 may automatically perform the actions to mitigate the security risk of having access to two or more applications 110 based on detecting that a likelihood that a user 185 is associated with a security risk by accessing the two or more applications 110 is above a threshold.

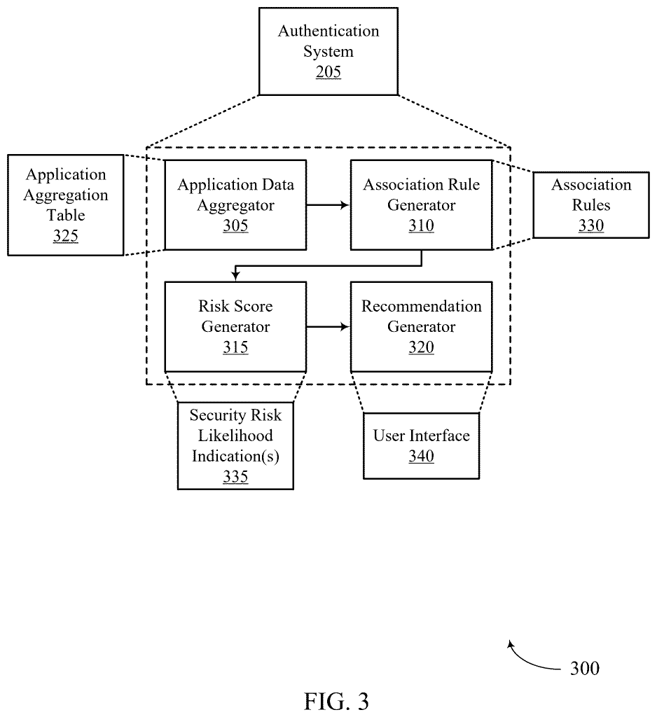

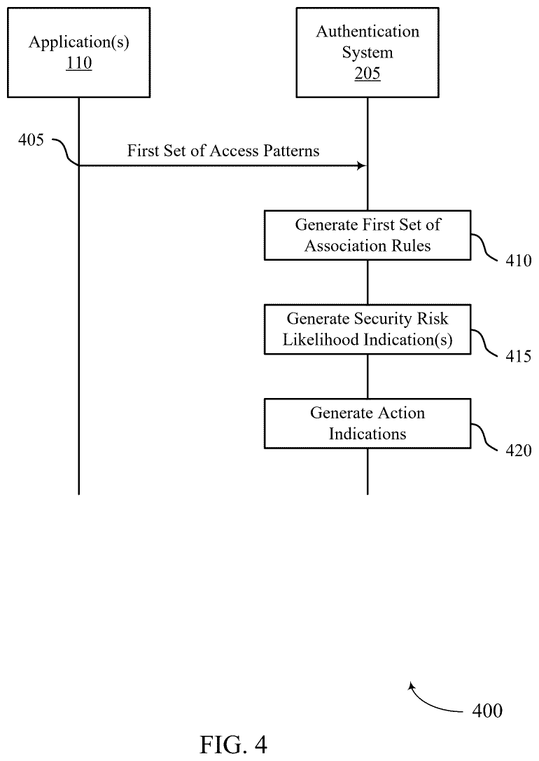

Thus, the techniques of the present disclosure may describe the authentication and authorization system 205 being capable of providing an indication of users 185 associated with security risks by having access to two or more applications 110 and reasons for administrative users 185 to investigate and act upon. Moreover, the techniques of the present disclosure may provide administrative users 185 the capability of auditing access policies and application 110 access of users 185 within an organization regardless of the quantity of applications 110 and the quantity of users 185 of the organization, thus providing a secure system for the organization. Further descriptions of the techniques of the present disclosure enabling the authentication and authorization system 205 to perform application association risk detection using association rule learning may be described elsewhere herein, such as with reference to FIGS. 3 and 4.

FIG. 3 shows an example of a block diagram 300 of an authentication and authorization system 205 that supports application association risk detection using association rule learning in accordance with aspects of the present disclosure. The block diagram 300 may implement or be implemented by the computing system 100, the computing system 200, or both. For example, the block diagram 300 may illustrate the components of the authentication and authorization system 205 that is described with reference to FIG. 2, that enables the authentication and authorization system 205 to support application association risk detection using association rule learning in accordance with aspects of the present disclosure. The authentication and authorization system 205 may include an application data aggregator 305, an association rule generator 310, a risk score generator 315, and a recommendation generator 320. In some examples, the authentication and authorization system 205, or one or more components of the authentication and authorization system 205 (e.g., the application data aggregator 305, the association rule generator 310, the risk score generator 315, the recommendation generator 320, or a combination thereof) may be hosted locally on a computing device 105 or within a cloud based platform (e.g., the cloud system 125). Further, each of these components may be in communication with one another (e.g., via one or more buses).

The application data aggregator 305 of the authentication and authorization system 205 may collect and aggregate application 110 access data from various users 185. In some examples, the application data aggregator 305 may collect aggregated application 110 data from all users 185 in an organization from the access events generated by access requests (e.g., access request 210) from users 185 successfully accessing applications 110. The application data aggregator 305 may further aggregate the access events (e.g., syslog events) into an application aggregation table 325 that indicates a first set of access patterns for a set of users of an organization. In some examples, the application aggregation table 325 may indicate which applications 110 each user 185 accesses within an organization. To generate the application aggregation table 325, the application data aggregator 305 may collect the access events, such as syslog events, generated when users 185 access applications 110 successfully. The application data aggregator 305 may then systematically organize these events into the application aggregation table 325, providing a structured view of user-application interactions. The application aggregation table 325 may facilitate the authentication and authorization system 205 in identifying a first set of access patterns by detailing the frequency and combination of applications accessed by each user 185. In some cases, an item of the application aggregation table 325 may correspond to a respective user 185 and may indicate which applications 110 that the respective user 185 has access to. For example, the application aggregation table 325 may aggregate all the access events stored in a data store (e.g., the data store 215 such as a syslog) to indicate each application 110 that a respective user 185 has successfully accessed. In some examples, the authentication and authorization system 205 may configure the application data aggregator 305 to update the application aggregation table 325 periodically or based on a trigger (e.g., based on a request or a threshold quantity of events being stored in the data store 215 since the last update, a request from an administrative user 185 to launch an audit campaign, and the like). As such, the authentication and authorization system 205 may receive the first set of access patterns from the applications 110 of the organization indicating which applications users 185 have access to via the application data aggregator 305 and the application aggregation table 325 generated by the application data aggregator 305.

The authentication and authorization system 205 may then use the application aggregation table 325 generated by the application data aggregator 305 to generate a set of association rules 330 via the association rule generator 310. The set of association rules 330 generated by the association rule generator 310 may be used to discover relations and associations between items in a relatively large dataset, such as the application aggregation table 325. The set of association rules 330 may be capable of identifying interesting insights in the application aggregation table 325. For example, the association rule generator 310 may be capable of generating a set of association rules 330 where the association between items may be defined as the applications 110 accessed together by a respective user.

To generate the set of association rules 330, the association rule generator 310 may process the first set of access patterns generated by the application data aggregator 305 by systematically analyzing the first set of access patterns to identify relationships between different applications 110 accessed by users 185. In some cases, to generate the set of association rules 330, the association rule generator 310 may generate item sets from the first set of access patterns. For example, as shown in Equation 1, the association rule generator 310 may generate a set of application 110 items, I, to indicate each application 110 accessed by the users 185 of an organization, where the quantity of applications 110 access is represented by m. Further, a combined set of application transactions for given user, T, may be a subset of the items as shown in Equation 2, where n indicates the quantity of users 185 within an organization, t indicates a respective application 110 transaction, and j indicates a respective user 185 of the set of users 185 within an organization. Moreover, the association rules may be logical rules in the form of A⇒C, where A is the antecedent and C is the consequent such that the association rule is read as “if A then C.” Thus, the association rule may indicate that if a user 185 accesses a first application A then they will also access a second application C.

$$I = \{ {i}_{1} , … , {i}_{m} \} \qquad ( 1 )$$

$$T = \{ {t}_{1} , … , {t}_{n} \} , {t}_{j} ⊆ I , j = 1 , … , n \qquad ( 2 )$$

Once the association rule generator 310 generates the itemset, I, and the set of association rules 330 that indicate the antecedents and consequents for the different application 110 combinations of users 185, the association rule generator 310 may calculate a support parameter as shown in Equation 3, a confidence parameter as shown in Equation 4, and a lift parameter as shown in Equation 5, for association risk scoring via the risk score generator 315. The support parameter may measure the frequency of a combination of applications 110 within the itemset. That is, the support parameter may indicate a frequency of a first application A and a second application C within the itemset. The confidence parameter may indicate a likelihood that a user 185 accessing the first application A will access the second application C. Thus, the confidence parameter may indicate a quantity of access patterns in the first set of access patterns where a user 185 that access the first application A then access the second application C. Further, the lift parameter may indicate a strength of the association between applications 110 thus indicating whether the occurrence of one application 110 influences the other. As such, the lift parameter may indicate whether an association between two applications 110 is a positive association, a negative association, or a neutral association.

$$support ( A \to C ) = support ( A ⋃ C ) , range : [ 0 , 1 ] \qquad ( 3 )$$

$$confidence ( A \to C ) = \frac{support ( A \to C )}{support ( A )} , range : [ 0 , 1 ] \qquad ( 4 )$$

$$lift ( A \to C ) = \frac{confidence ( A \to C )}{support ( C )} , range : [ 0 , ∞ ] \qquad ( 5 )$$

In some examples, the lift parameter may indicate a measure for the antecedent and consequent of a respective rule, A⇒C, to occur together. If the value of the lift parameter is above 1, lift(A→C)>1, then the lift parameter may indicate that the occurrence of the antecedent and the consequent are dependent on one another. For example, when the value of the lift parameter is above 1 for an application 110 association, accessing the second application 110 may be dependent on the first application 110. Further, if the value of the lift parameter is below 1, lift(A→C)<1, then the lift parameter may indicate that the presence of the antecedent has a negative effect on the presence of the consequent, thus indicating a weak association. Therefore, the association rule generator 310 may be capable of providing insights into user 185 behaviors and potential security risks by identifying unusual application 110 combinations. For example, some application 110 combinations may indicate security vulnerabilities within the organization.

Using the value of the lift parameters, the authentication and authorization system 205 may then utilize the risk score generator 315 to compute and assign risk scores for each respective user 185 to generate security risk likelihood indications 335 for each respective user 185 to indicate a likelihood that a respective user 185 is associated with a security risk for a corresponding application 110 association. In some examples, the risk score generator 315 may generate an association risk score (e.g., the security risk likelihood indications 335), via Equation 6, that indicates the likelihood that a respective user 185 is associated with a security risk. Additionally, or alternatively, the lift parameter used to generate the security risk likelihood indications 335 for a respective user 185 may be a combined lift parameter that is an average of the lift parameter value for each application 110 association of the respective user 185. In such cases, the security risk indication 335 may be an overall security risk indication 335 that is a combination of the security risk indication 335 of each application 110 association 110 that the user 185 has. For example, a respective user 185 may have access to 4 applications 110 (e.g., application A, application B, application C, and application D) and the association rule generator 310 may calculate a lift parameter for all 12 association combinations for the four applications (e.g., A⇒B, A⇒C, A⇒D, B⇒A, B⇒C, B⇒D, C⇒A, C⇒B, C⇒D, D⇒A, D⇒B, and D⇒C). Thus, the lift parameter value used in Equation 6 may be an average of all 12 lift parameter values. Further, if the risk score is less than or equal to 0 (e.g., the lift parameter value is greater than or equal to 1), the risk score may indicate a positive association and may be discarded or ignored as the application 110 association may not impact the security of a computing system. Thus, based on Equation 6 below, a negative association risk score may indicate a negative application 110 association and a positive association risk score or a association risk score of 0 may indicate a positive application 110 association.

$$Association Risk Score = 1 - lift , for lift < 1 \qquad ( 6 )$$

Once the risk score generator 315 generates the security risk likelihood indications 335 (e.g., the association risk scores) for each application 110 association for each respective user 185, the security risk likelihood indications 335 and a reason code may be added to a table. For example, a table may be generated where each item indicates a respective user 185, a list of applications 110 accessed by the user 185, a respective security risk likelihood indication 335 for the respective user 185, and a reason code for the security risk likelihood indication 335. In some cases, the reason code may indicate one or more application 110 associations that contribute to the security risk likelihood indication 335. For example, the security risk likelihood indication 335 may indicate that a respective user 185 may be associated with a relatively high security risk based on the association of two or more applications 110 that the respective user 185 has access to. Thus, the reason code for a security risk likelihood indication 335 may indicate the two or more applications 110 that a respective user 185 has access to that are considered to be ‘risky’ associations and result in a security risk for a tenant or organization.

Further, the risk score generator 315 of the authentication and authorization system 205 may transmit the security risk likelihood indications 335 to the recommendation generator 320 of the authentication and authorization system 205. Using the security risk likelihood indications 335, the recommendation generator 320 of the authentication and authorization system 205 may generate an indication of one or more actions for execution by the authentication and authorization system 205 based on the likelihood that a respective user 185 is associated with the security risk by accessing two or more applications 110. In some cases, the authentication and authorization system 205 may display an indication of one or more users 185 of the set of users 185 (e.g., a set of users 185 of an organization) that are associated with the security risk and the two or more applications 110 causing the security risk via a user interface 340. For example, based on the likelihood that the one or more users 185 are associated with a security risk by accessing two or more applications 110 as indicated via the respective security risk indications 335 satisfying a threshold, the recommendation generator 320 may display the one or more users 185 and the respective security risk indication 335 via the user interface 340. Additionally, or alternatively, the respective security risk indication 335 displayed via the user interface 340 may be an overall security risk indication 335 for a respective user 185 or a security risk indication 335 of two or more applications 110 that the respective user 185 has access to. For example, a respective user 185 may have multiple application 110 associations that have a security risk indication 335. Thus, the user interface 340 may display a security risk indication 335 that is a combination of each security risk indication 335 for each unsecure application 110 association that the respective user 185 has or the user interface 340 may display the security risk indication 335 for each application 110 association of the respective user 185 such that an administrator user 185 can view the individual application 110 association security risk indications 335 to determine a subsequent action to mitigate the security risk. For example, the recommendation generator 320 may also display the indication of the one or more actions for the one or more users via the user interface 340. Moreover, the recommendation generator 320 may generate the one or more actions based on the security risk indications 335 of the one or more users 185 satisfying the threshold.

In some examples, the one or more actions may include a recommendation for the authentication and authorization system 205 to adjust whether a user 185 should access a respective application 110. For example, if a security risk indication 335 for a user 185 accessing two or more applications 110 satisfies a threshold based on having access to the two or more applications 110, the recommendation generator 320 of the authentication and authorization system 205 may recommend for the access of a respective user 185 to a respective application 110 be removed. Moreover, in some cases, the one or more actions may indicate that one or more parameters of a user 185 should be adjusted. For example, the recommendation generator 320 may indicate via an action that the role assigned to a user 185 is incorrect and the recommendation generator 320 may recommend correcting the role assignment of a user 185. In response, the authentication and authorization system 205 may correct the role assignment of the user 185 which may prevent the user 185 from accessing one or more applications 110 thus reducing the value of an overall security risk indication 335 for the user 185 by removing an application 110 association that has a relatively high security risk. In some examples, an administrative user 185 may select an action for the authentication and authorization system 205 to execute via the user interface 340 based on viewing the indication of the one or more actions. In some other examples, the administrative user 185 may configure the authentication and authorization system 205 to automatically execute actions based on triggers. For example, the administrative user 185 may configure the authentication and authorization system 205 to automatically remove a respective user 185 from being capable of accessing one or more applications 110 if the one or more applications 110 are indicated as reasons for a security risk indication 335 value that satisfies a threshold value. Thus, the authentication and authorization system 205 may ensure that the applications 110 and systems of an organization remain secure by performing application 110 association risk detection using association rule learning in accordance with the techniques of the present disclosure. Further descriptions of the techniques of the present disclosure may be described elsewhere herein, such as with reference to FIG. 4.

FIG. 4 shows an example of a process flow 400 that supports application association risk detection using association rule learning in accordance with aspects of the present disclosure. In some examples, the process flow 400 may implement or may be implemented by the computing system 100, the computing system 200, the block diagram 300 of the authentication and authorization system 205, or any combination thereof. The process flow 400 may include one or more applications 110 and the authentication and authorization system 205, which may be examples of devices or services described elsewhere herein including with reference to FIG. 1.

In the following description of the process flow 400, the operations may be performed by the one or more applications 110 and the authentication and authorization system 205 in different orders or at different times. Some operations may also be left out of the process flow 400, or other operations may be added. Although the process flow 400 may be described as being performed by the one or more applications 110 and the authentication and authorization system 205, some aspects of some operations may also be performed by other devices, services, or models described elsewhere herein including with reference to FIGS. 1 through 3.

At 405, the authentication and authorization system 205 may receive, from two or more applications 110, a first set of access patterns associated with a set of users 185. The first set of access patterns may indicate which of the two or more applications 110 a respective user 185 has access to. In some examples, the first set of access patterns may be stored at a database, a data store (e.g., the data store 215), a cloud-based platform, or any combination thereof. Further, in some cases prior to receiving the first set of access patterns, the authentication and authorization system 205 may receive, from two or more applications 110, one or more access request messages from the set of users 185. The authentication and authorization system 205 may then aggregate the one or more access request messages into a first set of access patterns.

At 410, the authentication and authorization system 205 may generate a first set of association rules based on receiving the first set of access patterns. The first set of association rules may indicate associations between the two or more applications 110 and the set of users 185. In some cases, generating the first set of association rules may include the authentication and authorization system 205 generating an itemset that includes the first set of access patterns. Further, the authentication and authorization system 205 may calculate a support parameter that indicates a frequency of a first application 110 and a second application 110 within the itemset, calculate a confidence parameter that indicates a quantity of access patterns of the first set of access patterns that include both the first application 110 and the second application 110, and calculate a lift parameter that indicates an association between the first application 110 and the second application 110. Moreover, the first set of association rules may be based on the lift parameter for each pair of applications 110 of the two or more applications 110. Further, the association indicated by the lift parameter may be a positive association, a negative association, or a neutral association, based on a value of the lift parameter.

At 415, the authentication and authorization system 205 may generate, for each respective user 185, an indication of a likelihood that the respective user 185 is associated with a security risk by accessing the two or more applications 110 based on the first set of association rules and one or more parameters associated with the respective user 185. In some examples, the authentication and authorization system 205 may receive, from a first user 185 (e.g., an administrative user 185), a request to generate the indication of the likelihood that the respective user 185 is associated with the security risk for the set of users 185. In some cases, the authentication and authorization system 205 may identify that the likelihood that the respective user 185 is associated with the security risk by accessing the two or more applications 110 satisfies a threshold. In some other cases, the authentication and authorization system 205 may identify, from the applications 110 that the respective user 185 has access to, at least one application 110 pair of a set of application 110 pairs with a lift parameter value indicating a negative association. Further, the likelihood that the respective user 185 is associated with the security risk may be based on the at least one application 110 pair being associated with a negative association.

At 420, the authentication and authorization system 205 may generate an indication of one or more actions for execution by the authentication and authorization system 205 based on the likelihood that the respective user 185 is associated with the security risk by accessing the two or more applications 110. In some examples, the authentication and authorization system 205 may execute the one or more actions automatically and in response to generating the indication of the one or more actions, based on identifying satisfaction of a threshold. In some cases, the authentication and authorization system 205 may transmit, to a first user 185 (e.g., an administrative user 185), the indication of the one or more actions for execution by the authentication and authorization system 205. In response, the authentication and authorization system 205 may receive, from the first user 185 and based on transmitting the indication, a selection of at least one action of the one or more actions. Thus, based on receiving the selection from the first user 185, the authentication and authorization system 205 may execute at least one action. Moreover, the one or more actions may include an adjustment to an access parameter of a respective application 110 for the respective user 185, an adjustment of the one or more parameters associated with the respective user 185, an adjustment of the two or more applications 110 that the respective user 185 has access to, or any combination thereof. Additionally, or alternatively, the authentication and authorization system 205 may display, via a user interface, one or more users 185 of the set of users 185 that are associated with the security risk based on the likelihood that the one or more users 185 are associated with the security risk satisfying a threshold. Further, the authentication and authorization system 205 may also display, via the user interface and based on the one or more users 185 satisfying the threshold, the indication of the one or more actions for the one or more users 185.

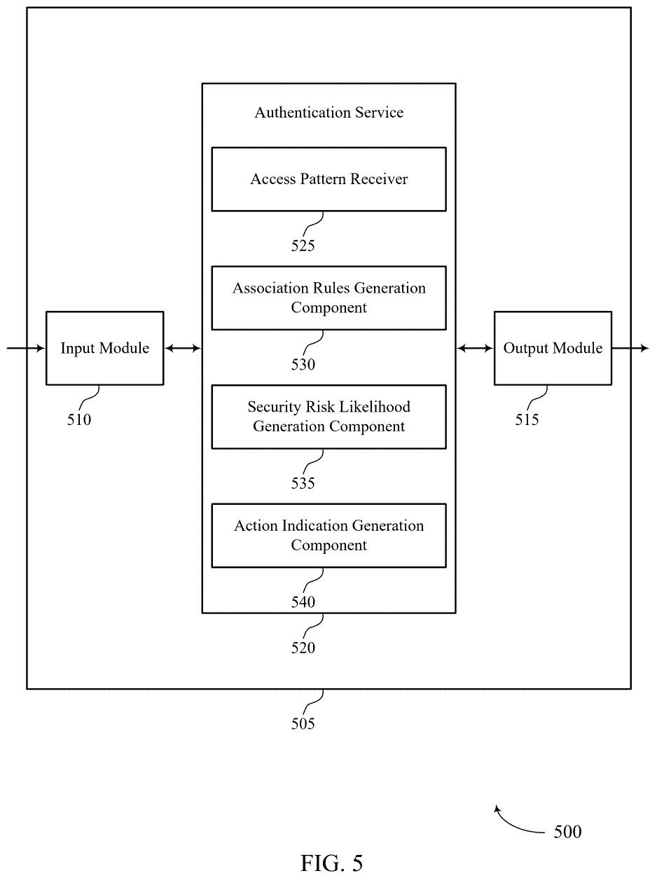

FIG. 5 shows a block diagram 500 of a device 505 that supports application association risk detection using association rule learning in accordance with aspects of the present disclosure. The device 505 may include an input module 510, an output module 515, and an authentication service 520. The device 505, or one or more components of the device 505 (e.g., the input module 510, the output module 515, the authentication service 520), may include at least one processor, which may be coupled with at least one memory, to support the described techniques. Each of these components may be in communication with one another (e.g., via one or more buses).

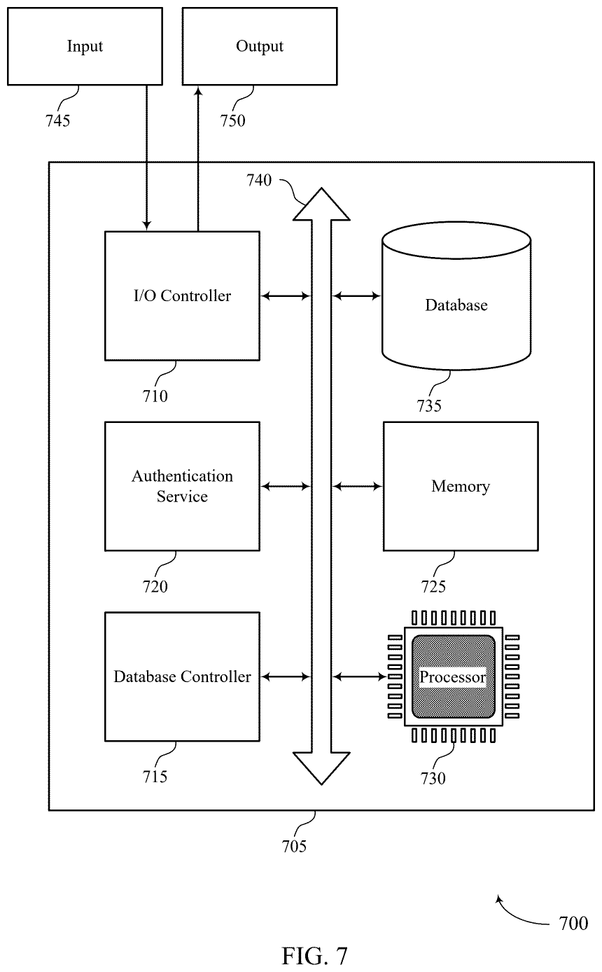

The input module 510 may manage input signals for the device 505. For example, the input module 510 may identify input signals based on an interaction with a modem, a keyboard, a mouse, a touchscreen, or a similar device. These input signals may be associated with user input or processing at other components or devices. In some cases, the input module 510 may utilize an operating system such as iOS®, ANDROID®, MS-DOS®, MS-WINDOWS®, OS/2®, UNIX®, LINUX®, or another known operating system to handle input signals. The input module 510 may send aspects of these input signals to other components of the device 505 for processing. For example, the input module 510 may transmit input signals to the authentication service 520 to support application association risk detection using association rule learning. In some cases, the input module 510 may be a component of an input/output (I/O) controller 710 as described with reference to FIG. 7.

The output module 515 may manage output signals for the device 505. For example, the output module 515 may receive signals from other components of the device 505, such as the authentication service 520, and may transmit these signals to other components or devices. In some examples, the output module 515 may transmit output signals for display in a user interface, for storage in a database or data store, for further processing at a server or server cluster, or for any other processes at any number of devices or systems. In some cases, the output module 515 may be a component of an I/O controller 710 as described with reference to FIG. 7.

For example, the authentication service 520 may include an access pattern receiver 525, an association rules generation component 530, a security risk likelihood generation component 535, an action indication generation component 540, or any combination thereof. In some examples, the authentication service 520, or various components thereof, may be configured to perform various operations (e.g., receiving, monitoring, transmitting) using or otherwise in cooperation with the input module 510, the output module 515, or both. For example, the authentication service 520 may receive information from the input module 510, send information to the output module 515, or be integrated in combination with the input module 510, the output module 515, or both to receive information, transmit information, or perform various other operations as described herein.

The authentication service 520 may support application-based risk detection in accordance with examples as disclosed herein. The access pattern receiver 525 may be configured to support receiving, from two or more applications, a first set of access patterns associated with a set of multiple users, the first set of access patterns indicating which of the two or more applications that a respective user has access to. The association rules generation component 530 may be configured to support generating, based on receiving the first set of access patterns, a first set of association rules that are based on the first set of access patterns, the first set of association rules indicating associations between the two or more applications and the set of multiple users. The security risk likelihood generation component 535 may be configured to support generating, for each respective user, an indication of a likelihood that the respective user is associated with a security risk by accessing the two or more applications based on the first set of association rules and one or more parameters associated with the respective user. The action indication generation component 540 may be configured to support generating an indication of one or more actions for execution by the authentication and authorization system based on the likelihood that the respective user is associated with the security risk.

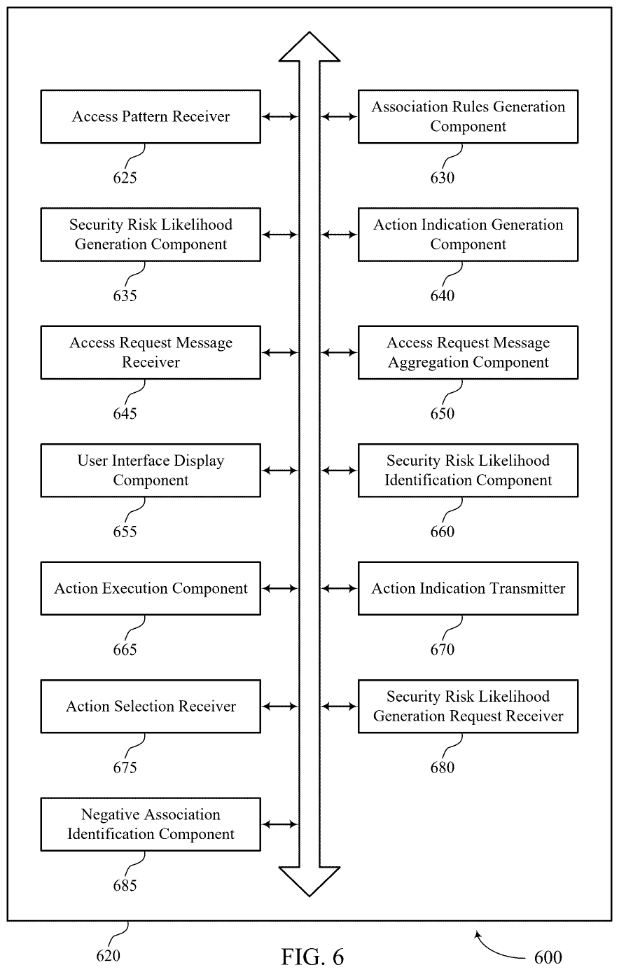

FIG. 6 shows a block diagram 600 of an authentication service 620 that supports application association risk detection using association rule learning in accordance with aspects of the present disclosure. The authentication service 620 may be an example of aspects of an authentication service or an authentication service 520, or both, as described herein. The authentication service 620, or various components thereof, may be an example of means for performing various aspects of application association risk detection using association rule learning as described herein. For example, the authentication service 620 may include an access pattern receiver 625, an association rules generation component 630, a security risk likelihood generation component 635, an action indication generation component 640, an access request message receiver 645, an access request message aggregation component 650, a user interface display component 655, a security risk likelihood identification component 660, an action execution component 665, an action indication transmitter 670, an action selection receiver 675, a security risk likelihood generation request receiver 680, a negative association identification component 685, or any combination thereof. Each of these components, or components of subcomponents thereof (e.g., one or more processors, one or more memories), may communicate, directly or indirectly, with one another (e.g., via one or more buses).

The authentication service 620 may support application-based risk detection in accordance with examples as disclosed herein. The access pattern receiver 625 may be configured to support receiving, from two or more applications, a first set of access patterns associated with a set of multiple users, the first set of access patterns indicating which of the two or more applications that a respective user has access to. The association rules generation component 630 may be configured to support generating, based on receiving the first set of access patterns, a first set of association rules that are based on the first set of access patterns, the first set of association rules indicating associations between the two or more applications and the set of multiple users. The security risk likelihood generation component 635 may be configured to support generating, for each respective user, an indication of a likelihood that the respective user is associated with a security risk by accessing the two or more applications based on the first set of association rules and one or more parameters associated with the respective user. The action indication generation component 640 may be configured to support generating an indication of one or more actions for execution by the authentication and authorization system based on the likelihood that the respective user is associated with the security risk.

In some examples, the access request message receiver 645 may be configured to support receiving, from the two or more applications, one or more access request messages from the set of multiple users. In some examples, the access request message aggregation component 650 may be configured to support aggregating the one or more access request messages into the first set of access patterns, where receiving the first set of access patterns is based on aggregating the one or more access request messages.

In some examples, the user interface display component 655 may be configured to support displaying, via a user interface, one or more users of the set of multiple users that are associated with the security risk based on the likelihood that the one or more users are associated with the security risk satisfying a threshold. In some examples, the user interface display component 655 may be configured to support displaying, via the user interface and based on the one or more users satisfying the threshold, the indication of the one or more actions for the one or more users, where the indication of the one or more actions is generated based on the one or more users satisfying the threshold.

In some examples, the security risk likelihood identification component 660 may be configured to support identifying that the likelihood that the respective user is associated with the security risk satisfies a threshold. In some examples, the action execution component 665 may be configured to support executing, automatically and in response to generating the indication of the one or more actions, the one or more actions based on identifying satisfaction of the threshold.

In some examples, the action indication transmitter 670 may be configured to support transmitting, to a first user, the indication of the one or more actions for execution by the authentication and authorization system. In some examples, the action selection receiver 675 may be configured to support receiving, from the first user and based on transmitting the indication, a selection of at least one action of the one or more actions. In some examples, the action execution component 665 may be configured to support executing the at least one action based on receiving the selection from the first user.

In some examples, the security risk likelihood generation request receiver 680 may be configured to support receiving, from a first user, a request to generate the indication of the likelihood that the respective user is associated with the security risk for the set of multiple users, where generation of the indication of the likelihood that the respective user is associated with the security risk is based on receiving the request from the first user.

In some examples, to support generating the first set of association rules, the association rules generation component 630 may be configured to support generating an itemset including the first set of access patterns. In some examples, to support generating the first set of association rules, the association rules generation component 630 may be configured to support calculating, utilizing the itemset, a support parameter that indicates a frequency of a first application and a second application within the itemset. In some examples, to support generating the first set of association rules, the association rules generation component 630 may be configured to support calculating, utilizing the itemset and based on the support parameter, a confidence parameter that indicates a quantity of access patterns of the first set of access patterns that include both the first application and the second application. In some examples, to support generating the first set of association rules, the association rules generation component 630 may be configured to support calculating, utilizing the itemset and based on both the support parameter and the confidence parameter, a lift parameter that indicates an association between the first application and the second application, where the first set of association rules are based on the lift parameter for each pair of applications of the two or more applications.

In some examples, the association indicated by the lift parameter is a positive association, a negative association, or a neutral association, based on a value of the lift parameter.

In some examples, the negative association identification component 685 may be configured to support identifying, from the applications that the respective user has access to, at least one application pair of a set of application pairs with a lift parameter value indicating a negative association, the likelihood that the respective user is associated with the security risk being based on the at least one application pair being associated with a negative association, where generating the indication of the likelihood that the respective user is associated with the security risk is based on identifying the at least one application pair.

In some examples, the first set of access patterns are stored at a database, a data store, a cloud-based platform, or any combination thereof.

In some examples, the one or more actions include an adjustment to an access parameter of a respective application for the respective user, an adjustment of the one or more parameters associated with the respective user, an adjustment of the two or more applications that the respective user has access to, or any combination thereof.

FIG. 7 shows a diagram of a system 700 including a device 705 that supports application association risk detection using association rule learning in accordance with aspects of the present disclosure. The device 705 may be an example of or include components of a device 505 as described herein. The device 705 may include components for bi-directional voice and data communications including components for transmitting and receiving communications, such as an authentication service 720, an I/O controller, such as an I/O controller 710, a database controller 715, at least one memory 725, at least one processor 730, and a database 735. These components may be in electronic communication or otherwise coupled (e.g., operatively, communicatively, functionally, electronically, electrically) via one or more buses (e.g., a bus 740).

The I/O controller 710 may manage input signals 745 and output signals 750 for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. In other cases, the I/O controller 710 may represent or interact with a modem, a keyboard, a mouse, a touchscreen, or a similar device. In some cases, the I/O controller 710 may be implemented as part of a processor 730. In some examples, a user may interact with the device 705 via the I/O controller 710 or via hardware components controlled by the I/O controller 710.

The database controller 715 may manage data storage and processing in a database 735. In some cases, a user may interact with the database controller 715. In other cases, the database controller 715 may operate automatically without user interaction. The database 735 may be an example of a single database, a distributed database, multiple distributed databases, a data store, a data lake, or an emergency backup database.

Memory 725 may include random-access memory (RAM) and read-only memory (ROM). The memory 725 may store computer-readable, computer-executable software including instructions that, when executed, cause at least one processor 730 to perform various functions described herein. In some cases, the memory 725 may contain, among other things, a basic I/O system (BIOS) which may control basic hardware or software operation such as the interaction with peripheral components or devices. The memory 725 may be an example of a single memory or multiple memories. For example, the device 705 may include one or more memories 725.

The processor 730 may include an intelligent hardware device (e.g., a general-purpose processor, a digital signal processor (DSP), a central processing unit (CPU), a microcontroller, an application-specific integrated circuit (ASIC), a field-programmable gate array (FPGA), a programmable logic device, a discrete gate or transistor logic component, a discrete hardware component, or any combination thereof). In some cases, the processor 730 may be configured to operate a memory array using a memory controller. In other cases, a memory controller may be integrated into the processor 730. The processor 730 may be configured to execute computer-readable instructions stored in at least one memory 725 to perform various functions (e.g., functions or tasks supporting application association risk detection using association rule learning). The processor 730 may be an example of a single processor or multiple processors. For example, the device 705 may include one or more processors 730.

The authentication service 720 may support application-based risk detection in accordance with examples as disclosed herein. For example, the authentication service 720 may be configured to support receiving, from two or more applications, a first set of access patterns associated with a set of multiple users, the first set of access patterns indicating which of the two or more applications that a respective user has access to. The authentication service 720 may be configured to support generating, based on receiving the first set of access patterns, a first set of association rules that are based on the first set of access patterns, the first set of association rules indicating associations between the two or more applications and the set of multiple users. The authentication service 720 may be configured to support generating, for each respective user, an indication of a likelihood that the respective user is associated with a security risk by accessing the two or more applications based on the first set of association rules and one or more parameters associated with the respective user. The authentication service 720 may be configured to support generating an indication of one or more actions for execution by the authentication and authorization system based on the likelihood that the respective user is associated with the security risk.

By including or configuring the authentication service 720 in accordance with examples as described herein, the device 705 may support techniques for an authentication and authorization system to detect that a respective user is associated with a security risk based on the applications the respective user has access to, thus providing the authentication and authorization system with improved security, improved reliability, and improved risk detection.

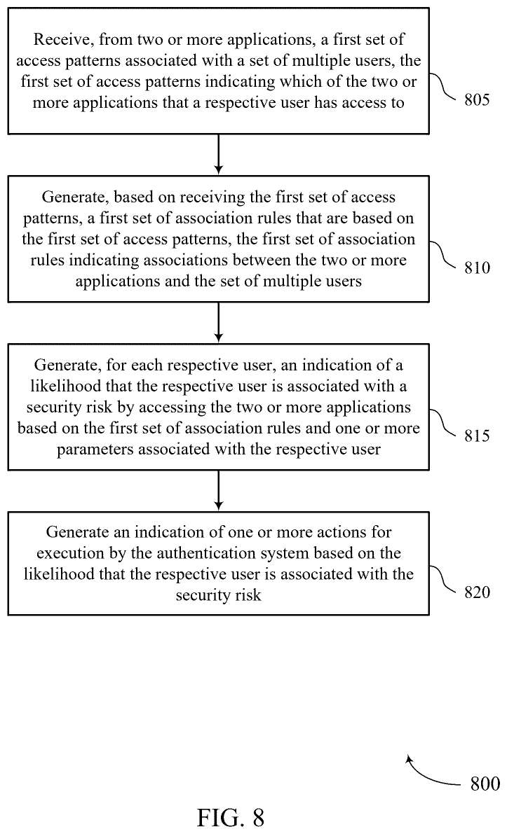

FIG. 8 shows a flowchart illustrating a method 800 that supports application association risk detection using association rule learning in accordance with aspects of the present disclosure. The operations of the method 800 may be implemented by an authentication and authorization system or its components as described herein. For example, the operations of the method 800 may be performed by an authentication and authorization system as described with reference to FIGS. 1 through 7. In some examples, an authentication and authorization system may execute a set of instructions to control the functional elements of the authentication and authorization system to perform the described functions. Additionally, or alternatively, the authentication and authorization system may perform aspects of the described functions using special-purpose hardware.

At 805, the method may include receiving, from two or more applications, a first set of access patterns associated with a set of multiple users, the first set of access patterns indicating which of the two or more applications that a respective user has access to. The operations of 805 may be performed in accordance with examples as disclosed herein. In some examples, aspects of the operations of 805 may be performed by an access pattern receiver 625 as described with reference to FIG. 6.

At 810, the method may include generating, based on receiving the first set of access patterns, a first set of association rules that are based on the first set of access patterns, the first set of association rules indicating associations between the two or more applications and the set of multiple users. The operations of 810 may be performed in accordance with examples as disclosed herein. In some examples, aspects of the operations of 810 may be performed by an association rules generation component 630 as described with reference to FIG. 6.

At 815, the method may include generating, for each respective user, an indication of a likelihood that the respective user is associated with a security risk by accessing the two or more applications based on the first set of association rules and one or more parameters associated with the respective user. The operations of 815 may be performed in accordance with examples as disclosed herein. In some examples, aspects of the operations of 815 may be performed by a security risk likelihood generation component 635 as described with reference to FIG. 6.

At 820, the method may include generating an indication of one or more actions for execution by the authentication and authorization system based on the likelihood that the respective user is associated with the security risk. The operations of 820 may be performed in accordance with examples as disclosed herein. In some examples, aspects of the operations of 820 may be performed by an action indication generation component 640 as described with reference to FIG. 6.

The following provides an overview of aspects of the present disclosure:

Aspect 1: A method for application-based risk detection by an authentication and authorization system, comprising: receiving, from two or more applications, a first set of access patterns associated with a plurality of users, the first set of access patterns indicating which of the two or more applications that a respective user has access to; generating, based at least in part on receiving the first set of access patterns, a first set of association rules that are based at least in part on the first set of access patterns, the first set of association rules indicating associations between the two or more applications and the plurality of users; generating, for each respective user, an indication of a likelihood that the respective user is associated with a security risk by accessing the two or more applications based at least in part on the first set of association rules and one or more parameters associated with the respective user; and generating an indication of one or more actions for execution by the authentication and authorization system based at least in part on the likelihood that the respective user is associated with the security risk.

Aspect 2: The method of aspect 1, further comprising: receiving, from the two or more applications, one or more access request messages from the plurality of users; and aggregating the one or more access request messages into the first set of access patterns, wherein receiving the first set of access patterns is based at least in part on aggregating the one or more access request messages.

Aspect 3: The method of any of aspects 1 through 2, further comprising: displaying, via a user interface, one or more users of the plurality of users that are associated with the security risk based at least in part on the likelihood that the one or more users are associated with the security risk satisfying a threshold; and displaying, via the user interface and based at least in part on the one or more users satisfying the threshold, the indication of the one or more actions for the one or more users, wherein the indication of the one or more actions is generated based at least in part on the one or more users satisfying the threshold.

Aspect 4: The method of any of aspects 1 through 3, further comprising: identifying that the likelihood that the respective user is associated with the security risk satisfies a threshold; and executing, automatically and in response to generating the indication of the one or more actions, the one or more actions based at least in part on identifying satisfaction of the threshold.

Aspect 5: The method of any of aspects 1 through 4, further comprising: transmitting, to a first user, the indication of the one or more actions for execution by the authentication and authorization system; receiving, from the first user and based at least in part on transmitting the indication, a selection of at least one action of the one or more actions; and executing the at least one action based at least in part on receiving the selection from the first user.

Aspect 6: The method of any of aspects 1 through 5, further comprising: receiving, from a first user, a request to generate the indication of the likelihood that the respective user is associated with the security risk for the plurality of users, wherein generation of the indication of the likelihood that the respective user is associated with the security risk is based at least in part on receiving the request from the first user.

Aspect 7: The method of any of aspects 1 through 6, wherein generating the first set of association rules comprises: generating an itemset comprising the first set of access patterns; calculating, utilizing the itemset, a support parameter that indicates a frequency of a first application and a second application within the itemset; calculating, utilizing the itemset and based at least in part on the support parameter, a confidence parameter that indicates a quantity of access patterns of the first set of access patterns that include both the first application and the second application; and calculating, utilizing the itemset and based at least in part on both the support parameter and the confidence parameter, a lift parameter that indicates an association between the first application and the second application, wherein the first set of association rules are based at least in part on the lift parameter for each pair of applications of the two or more applications.

Aspect 8: The method of aspect 7, wherein the association indicated by the lift parameter is a positive association, a negative association, or a neutral association, based at least in part on a value of the lift parameter.

Aspect 9: The method of aspect 8, further comprising: identifying, from the applications that the respective user has access to, at least one application pair of a set of application pairs with a lift parameter value indicating a negative association, the likelihood that the respective user is associated with the security risk being based at least in part on the at least one application pair being associated with a negative association, wherein generating the indication of the likelihood that the respective user is associated with the security risk is based at least in part on identifying the at least one application pair.

Aspect 10: The method of any of aspects 1 through 9, wherein the first set of access patterns are stored at a database, a data store, a cloud-based platform, or any combination thereof.

Aspect 11: The method of any of aspects 1 through 10, wherein the one or more actions comprise an adjustment to an access parameter of a respective application for the respective user, an adjustment of the one or more parameters associated with the respective user, an adjustment of the two or more applications that the respective user has access to, or any combination thereof.

Aspect 12: An authentication and authorization system for application-based risk detection, comprising one or more memories storing processor-executable code, and one or more processors coupled with the one or more memories and individually or collectively operable to execute the code to cause the authentication and authorization system to perform a method of any of aspects 1 through 11.

Aspect 13: An authentication and authorization system for application-based risk detection, comprising at least one means for performing a method of any of aspects 1 through 11.

Aspect 14: A non-transitory computer-readable medium storing code for application-based risk detection, the code comprising instructions executable by one or more processors to perform a method of any of aspects 1 through 11.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations, and does not represent all the examples that may be implemented, or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by one or more processors, firmware, or any combination thereof. If implemented in software executed by one or more processors, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for application-based risk detection by an authentication and authorization system, comprising:
receiving, from two or more applications, a first set of access patterns associated with a plurality of users, the first set of access patterns indicating which of the two or more applications that a respective user has access to;
generating, based at least in part on receiving the first set of access patterns, a first set of association rules that are based at least in part on the first set of access patterns, the first set of association rules indicating associations between the two or more applications and the plurality of users;
generating, for each respective user, an indication of a likelihood that the respective user is associated with a security risk by accessing the two or more applications based at least in part on the first set of association rules and one or more parameters associated with the respective user; and
generating an indication of one or more actions for execution by the authentication and authorization system based at least in part on the likelihood that the respective user is associated with the security risk.

2. The method of claim 1, further comprising:
receiving, from the two or more applications, one or more access request messages from the plurality of users; and
aggregating the one or more access request messages into the first set of access patterns, wherein receiving the first set of access patterns is based at least in part on aggregating the one or more access request messages.

3. The method of claim 1, further comprising:
displaying, via a user interface, one or more users of the plurality of users that are associated with the security risk based at least in part on the likelihood that the one or more users are associated with the security risk satisfying a threshold; and
displaying, via the user interface and based at least in part on the one or more users satisfying the threshold, the indication of the one or more actions for the one or more users, wherein the indication of the one or more actions is generated based at least in part on the one or more users satisfying the threshold.

4. The method of claim 1, further comprising:
identifying that the likelihood that the respective user is associated with the security risk satisfies a threshold; and
executing, automatically and in response to generating the indication of the one or more actions, the one or more actions based at least in part on identifying satisfaction of the threshold.

5. The method of claim 1, further comprising:
transmitting, to a first user, the indication of the one or more actions for execution by the authentication and authorization system;
receiving, from the first user and based at least in part on transmitting the indication, a selection of at least one action of the one or more actions; and
executing the at least one action based at least in part on receiving the selection from the first user.

6. The method of claim 1, further comprising:
receiving, from a first user, a request to generate the indication of the likelihood that the respective user is associated with the security risk for the plurality of users, wherein generation of the indication of the likelihood that the respective user is associated with the security risk is based at least in part on receiving the request from the first user.

7. The method of claim 1, wherein generating the first set of association rules comprises:
generating an itemset comprising the first set of access patterns;
calculating, utilizing the itemset, a support parameter that indicates a frequency of a first application and a second application within the itemset;
calculating, utilizing the itemset and based at least in part on the support parameter, a confidence parameter that indicates a quantity of access patterns of the first set of access patterns that include both the first application and the second application; and
calculating, utilizing the itemset and based at least in part on both the support parameter and the confidence parameter, a lift parameter that indicates an association between the first application and the second application, wherein the first set of association rules are based at least in part on the lift parameter for each pair of applications of the two or more applications.

8. The method of claim 7, wherein the association indicated by the lift parameter is a positive association, a negative association, or a neutral association, based at least in part on a value of the lift parameter.

9. The method of claim 8, further comprising:
identifying, from the applications that the respective user has access to, at least one application pair of a set of application pairs with a lift parameter value indicating a negative association, the likelihood that the respective user is associated with the security risk being based at least in part on the at least one application pair being associated with a negative association, wherein generating the indication of the likelihood that the respective user is associated with the security risk is based at least in part on identifying the at least one application pair.

10. The method of claim 1, wherein the first set of access patterns are stored at a database, a data store, a cloud-based platform, or any combination thereof.

11. The method of claim 1, wherein the one or more actions comprise an adjustment to an access parameter of a respective application for the respective user, an adjustment of the one or more parameters associated with the respective user, an adjustment of the two or more applications that the respective user has access to, or any combination thereof.

12. An authentication and authorization system for application-based risk detection, comprising:
one or more memories storing processor-executable code; and
one or more processors coupled with the one or more memories and individually or collectively operable to execute the code to cause the authentication and authorization system to:
receive, from two or more applications, a first set of access patterns associated with a plurality of users, the first set of access patterns indicating which of the two or more applications that a respective user has access to;
generate, based at least in part on receiving the first set of access patterns, a first set of association rules that are based at least in part on the first set of access patterns, the first set of association rules indicating associations between the two or more applications and the plurality of users;
generate, for each respective user, an indication of a likelihood that the respective user is associated with a security risk by accessing the two or more applications based at least in part on the first set of association rules and one or more parameters associated with the respective user; and
generate an indication of one or more actions for execution by the authentication and authorization system based at least in part on the likelihood that the respective user is associated with the security risk.

13. The authentication and authorization system of claim 12, wherein the one or more processors are individually or collectively further operable to execute the code to cause the authentication and authorization system to:
receive, from the two or more applications, one or more access request messages from the plurality of users; and
aggregate the one or more access request messages into the first set of access patterns, wherein receiving the first set of access patterns is based at least in part on aggregating the one or more access request messages.

14. The authentication and authorization system of claim 12, wherein the one or more processors are individually or collectively further operable to execute the code to cause the authentication and authorization system to:
display, via a user interface, one or more users of the plurality of users that are associated with the security risk based at least in part on the likelihood that the one or more users are associated with the security risk satisfying a threshold; and
display, via the user interface and based at least in part on the one or more users satisfying the threshold, the indication of the one or more actions for the one or more users, wherein the indication of the one or more actions is generated based at least in part on the one or more users satisfying the threshold.

15. The authentication and authorization system of claim 12, wherein the one or more processors are individually or collectively further operable to execute the code to cause the authentication and authorization system to:
identify that the likelihood that the respective user is associated with the security risk satisfies a threshold; and
execute, automatically and in response to generating the indication of the one or more actions, the one or more actions based at least in part on identifying satisfaction of the threshold.

16. The authentication and authorization system of claim 12, wherein the one or more processors are individually or collectively further operable to execute the code to cause the authentication and authorization system to:
transmit, to a first user, the indication of the one or more actions for execution by the authentication and authorization system;
receive, from the first user and based at least in part on transmitting the indication, a selection of at least one action of the one or more actions; and
execute the at least one action based at least in part on receiving the selection from the first user.

17. The authentication and authorization system of claim 12, wherein, to generate the first set of association rules, the one or more processors are individually or collectively operable to execute the code to cause the authentication and authorization system to:
generate an itemset comprising the first set of access patterns;
calculate, utilizing the itemset, a support parameter that indicates a frequency of a first application and a second application within the itemset;
calculate, utilizing the itemset and based at least in part on the support parameter, a confidence parameter that indicates a quantity of access patterns of the first set of access patterns that include both the first application and the second application; and
calculate, utilizing the itemset and based at least in part on both the support parameter and the confidence parameter, a lift parameter that indicates an association between the first application and the second application, wherein the first set of association rules are based at least in part on the lift parameter for each pair of applications of the two or more applications.

18. A non-transitory computer-readable medium storing code for application-based risk detection, the code comprising instructions executable by one or more processors to:
receive, from two or more applications, a first set of access patterns associated with a plurality of users, the first set of access patterns indicating which of the two or more applications that a respective user has access to;
generate, based at least in part on receiving the first set of access patterns, a first set of association rules that are based at least in part on the first set of access patterns, the first set of association rules indicating associations between the two or more applications and the plurality of users;
generate, for each respective user, an indication of a likelihood that the respective user is associated with a security risk by accessing the two or more applications based at least in part on the first set of association rules and one or more parameters associated with the respective user; and
generate an indication of one or more actions for execution by an authentication and authorization system based at least in part on the likelihood that the respective user is associated with the security risk.

19. The non-transitory computer-readable medium of claim 18, wherein the instructions are further executable by the one or more processors to:
display, via a user interface, one or more users of the plurality of users that are associated with the security risk based at least in part on the likelihood that the one or more users are associated with the security risk satisfying a threshold; and
display, via the user interface and based at least in part on the one or more users satisfying the threshold, the indication of the one or more actions for the one or more users, wherein the indication of the one or more actions is generated based at least in part on the one or more users satisfying the threshold.

20. The non-transitory computer-readable medium of claim 18, wherein the instructions are further executable by the one or more processors to:
identify that the likelihood that the respective user is associated with the security risk satisfies a threshold; and
execute, automatically and in response to generating the indication of the one or more actions, the one or more actions based at least in part on identifying satisfaction of the threshold.
